(19) United States
(12) Patent Application Publication
(10) Pub. No.: US 2014/0125307 A1
(43) Pub. Date: May 8, 2014

(54) SYNCHRONIZED SELF-REFERENCED HIGH VOLTAGE ALTERNATING CURRENT POWER SAVING REGENERATOR SWITCH SYSTEM

(71) Applicant: Fred Verd, Santee, CA (US)

(72) Inventor: Fred Verd, Santee, CA (US)

(21) Appl. No.: 13/668,205

(22) Filed: Nov. 2, 2012

(51) Int. Cl. G05F 3/04

(52) U.S. Cl. 323/312

(57) ABSTRACT

A method and apparatus for self-referenced Alternating Current (AC) voltage chopping using non-linear dual switches configured in series with the Load to regulate voltage according to a positive or negative instantaneous voltage value and a positive going or negative going state is disclosed. Power applied to inductive Loads is conserved by automatically tracking the current demand of the Load and reusing the reactive energy held by the Load. A source AC power signal is converted to a representative digital logic square wave pulse signal referenced to ground, and conditioned for precision timing of power and regeneration switching circuits. Power and regeneration switching circuits are differential circuits referenced only to themselves. These floating circuits are not Direct Current circuits and are never referenced to ground or any specific voltage. The value of the source voltage is irrelevant because the differential voltage is re-routed on to itself.

### BACKGROUND

1. Field

The present invention relates generally to Alternating Current voltage regulation, and more specifically to Alternating Current power regeneration.

2. Background

Modern society creates an ever increasing demand for power. Such power demands are costly to meet and invariably produce a negative impact on our environment. Much of all power produced is consumed by operating inductive Loads such as motors that drive pumps, compressors, and other mechanical devices including elevators, escalators, or industrial equipment. Many methods for conserving Alternating Current (AC) power when driving inductive Loads have been theorized and proposed. Voltage chopping regulation has occasionally been the subject of such theories and proposals. Invariably, these attempts have been met with failure to adequately enable, or actually produce, a working prototype of a voltage chopping device for conserving AC power.

Failed voltage regulation circuits applied in parallel with inductive Loads have been tried and proven to duly short the switching circuits as well as destroy the Load itself. Attempts to reference both positive and negative power supplies for switching the Load have likewise failed because of inadequate isolation of the AC supply from switching control circuits. These areas of inadequate design have comprised grounding circuits employing P-Channel and N-Channel Bipolar Junction Transistors (BJTs) to switch the Load circuit to ground have again proved fatal to the device as well as the Load.

A patented theory, highly similar to an IEEE publication, discloses another parallel switch having two gate signals for each signal path requiring four total switches. Again, these switches are configured in parallel with the Load and can neither drive the Load nor conserve power adequately due to individual timing and signal integrity issues related to the four separate gate signals.

There is therefore a need in the art for a reliable method and apparatus to conserve AC power while driving inductive Loads that can be implemented and used, rather than pondered and discussed, while power demand grows daily along with its environmental damage and monetary expense not to mention dependence on foreign oil.

### SUMMARY

Embodiments disclosed herein address the above stated needs by providing working differential circuits for chopping high voltages in order to save power. In one aspect, a high voltage switching system for saving power comprises an edge conditioning circuit for adjusting timing of a digital logic square wave pulse signal for input to high voltage gate driver circuits synchronized to an Alternating Current power source, a high voltage power gate driver circuit for converting the timing adjusted digital logic square wave pulse signal to a power digital square wave pulse signal referenced to an Alternating Current power source for controlling a power switching circuit in a power mode, a high voltage regeneration gate driver circuit for converting the timing adjusted digital logic square wave pulse signal to a power digital square wave pulse signal referenced to an Alternating Current power source for controlling a regeneration switching circuit in a regeneration mode, a high voltage differential power switching circuit referenced to an Alternating Current power source configured in series with a reactive load for supplying power from the Alternating Current power source to the load in the power mode, and a high voltage differential regeneration switching circuit referenced to an Alternating Current power source configured in series with the reactive load for saving power by reusing energy held by the load.

In another aspect, a method for saving power in high voltage devices comprises adjusting timing of a digital logic square wave pulse signal for input to high voltage gate driver circuits synchronized to an Alternating Current power source, converting the timing adjusted digital logic square wave pulse signal to a power digital square wave pulse signal referenced to an Alternating Current power source for controlling a power switching circuit in a power mode, converting the timing adjusted digital logic square wave pulse signal to a power digital square wave pulse signal referenced to an Alternating Current power source for controlling a regeneration switching circuit in a regeneration mode, referencing a high voltage differential power switching circuit to an Alternating Current power source configured in series with a reactive load for supplying power from the Alternating Current power source to the load in the power mode, and referencing a high voltage differential regeneration switching circuit to an Alternating Current power source configured in series with the reactive load for saving power by reusing energy held by the load.

In yet another aspect, a method for adjusting timing of a digital logic square wave pulse signal for input to a high voltage gate driver circuit synchronized to an Alternating Current power source comprising, buffering, delaying and sampling signal pulses for logic control of high power switches, summing and comparing the signal pulses to calculate critical timing adjustments, adjusting timing of a digital logic square wave pulse signal according to the calculations.

### BRIEF DESCRIPTION OF THE DRAWINGS

FIG. 1 is a high level overview block diagram illustrating an example synchronized self-referenced high voltage alternating current power saving regenerator switch system;

FIG. 2 is an exemplary flow diagram illustrating startup synchronization of a synchronized self-referenced high voltage alternating current power saving regenerator switch system;

FIG. 3 is an exemplary flow diagram illustrating signal edge conditioning of a synchronized self-referenced high voltage alternating current power saving regenerator switch system;

FIG. 4 is an exemplary flow diagram illustrating power gating of a synchronized self-referenced high voltage alternating current power saving regenerator switch system;

FIG. 5 is an exemplary flow diagram illustrating power regeneration gating of a synchronized self-referenced high voltage alternating current power saving regenerator switch system;

FIG. 6A is an exemplary functional block diagram illustrating power gating mode of a synchronized self-referenced high voltage alternating current power saving regenerator switch system;

FIG. 6B is an exemplary functional block diagram illustrating power regeneration mode of a synchronized self-referenced high voltage alternating current power saving regenerator switch system;

FIG. 7 is a schematic diagram of an exemplary power gate and power regeneration gate circuit of a synchronized self-referenced high voltage alternating current power saving regenerator switch system;

FIG. 8 is an exemplary illustration of an original AC Source power signal input to a synchronized self-referenced high voltage alternating current power saving regenerator switch system;

FIG. 9 is an exemplary illustration of a digital logic square wave output signal of a Voltage Monitoring Circuit;

FIG. 10 is an exemplary illustration of a digital logic square wave output signal of a Steady State Synchronous Timing Circuit;

FIG. 11 is an exemplary illustration of a digital logic square wave output signal of a Pulse Forming Circuit;

FIG. 12 is an exemplary illustration of a digital logic square wave output signal of a Startup Synchronization Circuit;

FIG. 13A illustrates four case variations over time of an AC input signal voltage creating four different operational states in a synchronized self-referenced high voltage alternating current power saving regenerator switch system;

FIG. 13B is an exemplary illustration of a digital logic square wave output signal of the Edge Conditioning Circuit;

FIG. 14 is an exemplary illustration of a power digital square wave pulse output signal of a Power Gate Driver Circuit;

FIG. 15 is an exemplary illustration of a power digital square wave pulse output signal of a Regeneration Gate Driver Circuit;

FIG. 16 is an exemplary illustration of a power digital square wave pulse output signal of a Power Switching Circuit or a Regeneration Switching Circuit where the AC Source Frequency is Chopped 16 with a 50% Regeneration Period;

FIG. 17 is an exemplary illustration of a power digital square wave pulse output signal of a Power Switching Circuit or a Regeneration Switching Circuit where the AC Source Frequency is Chopped 16 times with a 25% Regeneration Period; and

FIG. 18 is an exemplary illustration of a power digital square wave pulse output signal of a Power Switching Circuit or a Regeneration Switching Circuit where the AC Source Frequency is Chopped 32 times with a 50% Regeneration Period.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

A method and apparatus for self-referenced AC voltage chopping using precision dual switch sets configured in series with the Load to regulate voltage according to a positive or negative instantaneous voltage value and a positive going or negative going input signal slope is disclosed. 10% to 70% of power applied to inductive Loads is conserved by automatically tracking the current demand of the Load and reusing the reactive energy held by the Load.

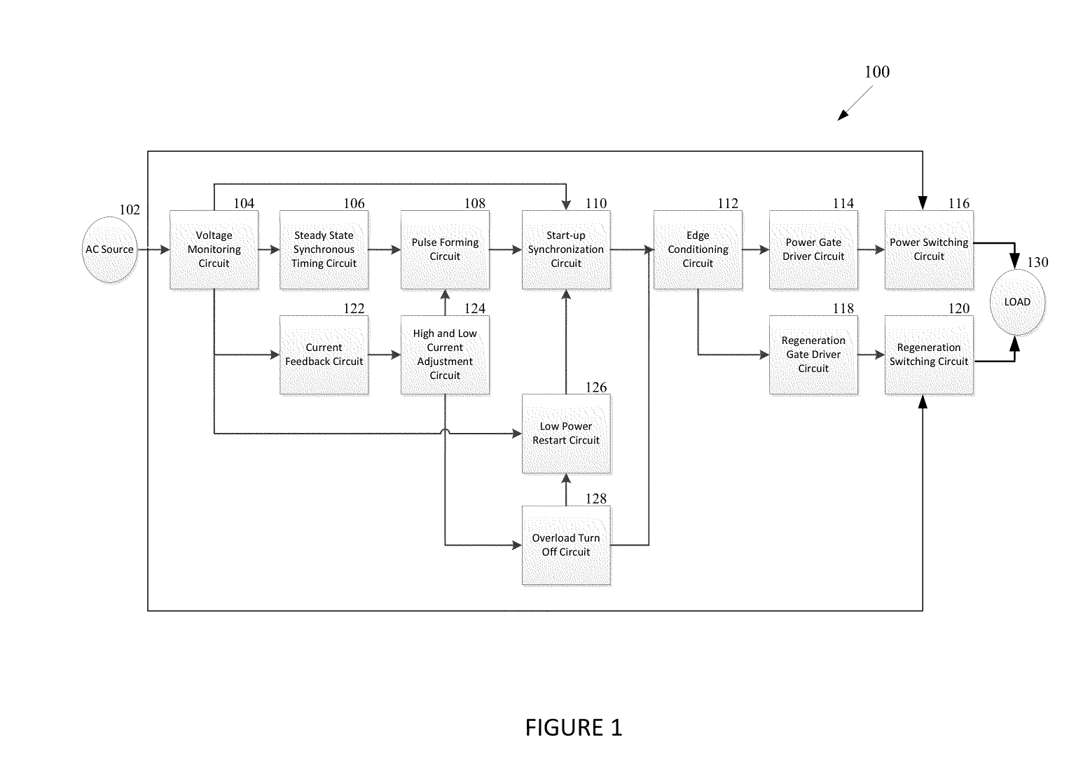

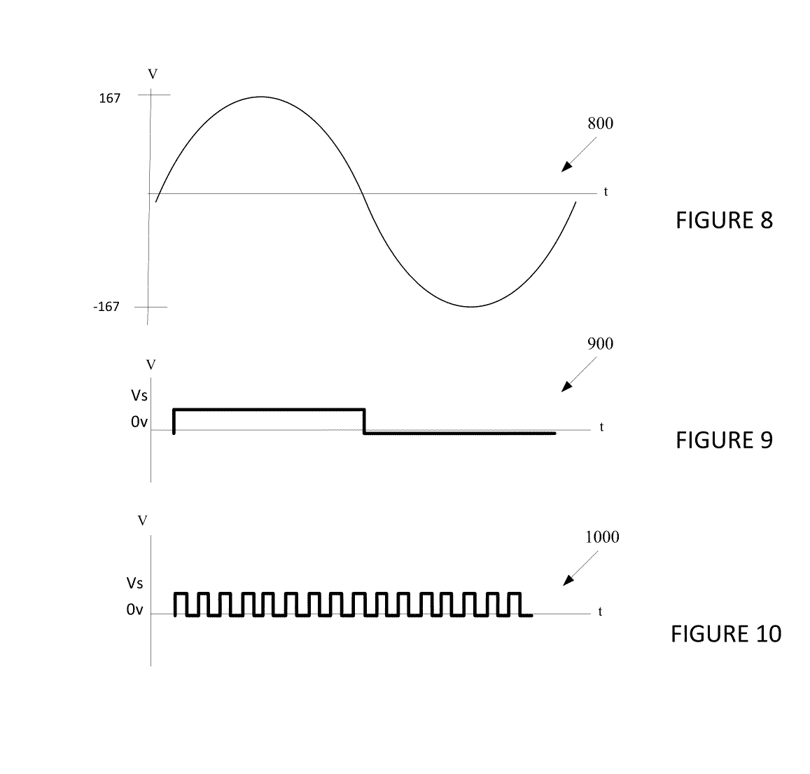

FIG. 1 is a high level overview block diagram illustrating an example synchronized self-referenced high voltage alternating current power saving regenerator switch system 100 configured in series with an inductive Load. The AC Source, or Alternating Current Source, represents the power delivery system 102. In the United States the typical power grid supplying power to a house or residence is 240 Volts Alternating Current (VAC) at 60 Hertz (Hz), which is split by a transformer to also supply at least 2 circuits of 120 VAC at 60 Hz. Industrial areas or businesses in the United State are typically supplied with 120 VAC 3 phase 60 Hz and/or 220 VAC 3 phase 60 Hz power. Other European countries are supplied with 230 VAC at 50 Hz. There may be other standards. However, most power delivery systems use Alternating Current (AC) as their method of transferring electrical power over long distances. The AC source is applied to a Voltage Monitoring Circuit 104. The AC source 102 input signal is detailed in FIG. 8.

The Voltage Monitoring Circuit 104 monitors the voltage at the input and sends an AC Source 102 signal to the Low Power Restart Circuit 126, which analyzes the signal for interruption in power. If the voltage at the input is interrupted for any reason, the Low Power Restart Circuit 126 sends a control signal to the Start-up Synchronization Circuit 110, which restarts (i.e. reboots) and resynchronizes the system 100. This reboot comprises a delay that turns off duel synchronized switches in the Power Switching Circuit 116 and the Regeneration Switching Circuit 120 for an adequate amount of time to ensure power is restored such that all power supplies for the system are energized at their normal operating voltages before restarting operation. In other words, the Low Power Restart Circuit 126 sets thresholds for high and low power and monitors input voltage to determine if it is too low relative to the Load by comparing it to a pre-determined threshold. The analog AC Source 102 signal is converted to an equivalent digital logic square wave pulse signal before being output to the Startup Synchronization Circuit 110. If there is not enough voltage input to the Low Power Restart Circuit 126, it will issue a control signal to the Startup Synchronization Circuit 110 to resynchronize all of the system 100 signals and switching logic.

The Low Power Restart Circuit 126 acts as a voltage monitoring system for the low power restart mechanism. The Low Power Restart Circuit 126 causes the Start-up Synchronization Circuit 110 to turn off the logic gate switching until a restart sequence re-enables a synchronized restart at any time low power is detected.

The Voltage Monitoring Circuit 104 also outputs an AC Source 102 signal to the Current Feedback Circuit 122, which protects the system from current overdraws and is then also used for pulse forming of the digital logic square wave pulse signal by a Pulse Forming Circuit 108. Thus, the Voltage Monitoring Circuit 104 ensures that there are no interruptions in the incoming AC Source 102 power signal. The system 100 is reset and resynchronized at any time the Voltage Monitoring Circuit 104 detects an interruption of the source AC 102 signal. The Voltage Monitoring Circuit 104 converts the normal AC Source 102 sine wave input to an uninterrupted equivalent digital logic square wave signal for simultaneous output to the Steady State Synchronous Timing Circuit 106 and the Startup Synchronization Circuit 110. The output signal of the Voltage Monitoring Circuit 104 is detailed in FIG. 9.

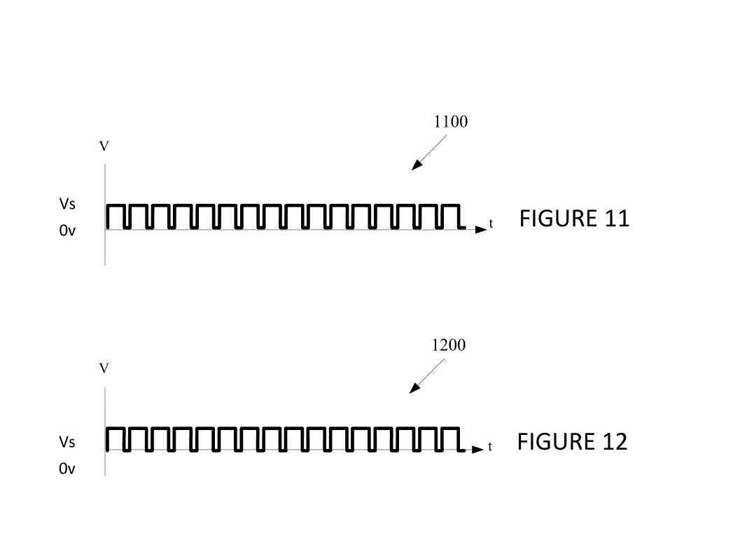

The Steady State Synchronous Timing Circuit 106 sets a timing synchronization signal, or clock reference signal, exactly referenced to the incoming AC Source 102 power signal. This synchronized clock reference signal is then used as a clock reference for the timing of all system 100 components and circuits. The precision referenced clock signal is then sampled and used as a reference to produce a plurality of other reference signals at exact frequency multiples of the original clock reference signal. These additional clock reference signals are exact integer multiplies of the original square wave output by the Voltage Monitoring Circuit 104. Multiples may comprise the clock reference signal multiplied by any integer. In a digital system, a binary integer or 2 to the Nth such as 2, 4, 8, 16, 32 . . . may facilitate synchronization. In some embodiments, a prime number such as 3, 5, 7, 11, 17, 19, 23 . . . may facilitate isolation of the AC supply from switching control circuits. For simplicity, multiples of 16 and 32 times the original clock reference signal are detailed in FIGS. 9 and 11. For example, a 60 cycle square wave multi 32 in synchronization with the original AC signal may be produced. The clock reference signal is then output to the Pulse Forming Circuit 108.

The Steady State Synchronous Timing Circuit 106 operates by creating a buffered steady state digital logic square wave pulse signal from the uninterrupted equivalent digital logic square wave signal output of the Voltage Monitoring Circuit 104 synchronized to the frequency of the incoming AC source 102, typically 60 Hz. The voltage level of the digital logic square wave signal equals the value of the system logic voltage (Vs) for all of following digital logic components. This system logic voltage may be any voltage used by the internal digital logic gate system components later processing the signal. For example, a TTL system operates at 3.3 volts. The highly synchronized digital logic square wave pulses are later used to drive the high voltage Power 602 and Regeneration switches 604. These highly synchronized clock pulses prevent any random or unsynchronized operation of the high voltage Power 602 and Regeneration switches 604. In alternative embodiments, analog phase lock loops or other methods may be used to synchronize system timing as long as they are sufficiently stable and precisely synchronized. These uninterrupted multiplied synchronized square wave signals having a voltage level equal to the system logic voltage and the output from a High and Low current Adjuster Circuit 124 are input to the Pulse Forming Circuit 108. The output signal of the Steady State Synchronous timing circuit is detailed in FIG. 10.

The AC Source 102 signal outputs of the Voltage Monitoring Circuit 104 provide input to the Current Feedback Circuit 122 and the Low Power Restart Circuit 126, circuits that are designed to match the voltage requirements of the system switching logic. The Current Feedback Circuit 122 and the High and Low Current Adjustment Circuit 124 work in conjunction to provide control signals for use by the Pulse Forming Circuit 108 in determining duty cycles according to the amount of current drawn by the Load 130, and validating current values input to Pulse Forming Circuit 108, respectively. The Current Feedback Circuit 122 comprises a current sensor that measures the amount of current supplied by the AC Source to the Load 130. An averaged DC signal is output to the High and Low Current Adjustment Circuit 124 for analysis.

The High and Low Current Adjustment Circuit 124 operates to validate current provided to the Pulse Forming Circuit 108 by setting high and low current thresholds and comparing the input averaged DC signal to the thresholds. Thresholds may be fixed according to the requirements of known Loads. Alternatively, manual adjusters may also be provided for setting thresholds. The high and low current threshold settings are adjusted according to the power requirements of the Load 130 in order to improve the efficiency of the Load 130. If the averaged DC signal has a value greater than the high current threshold, the Over Load Turn Off Circuit 128 issues a control signal to the Low Power Restart Circuit 126 and the Edge Conditioning Circuit 112 to generate a startup sequence control signal, which causes all of the system logic components and circuits to turn off and the system 100 to restart and resynchronize the system 100. Thus, the Over Load Turn Off circuit 128 receives control input from the High and Low Current Adjustment Circuit 122 to determine if too much current is being drawn. If a current overdraw occurs, the Over Load Turn Off Circuit 128 sends a control signal directly to the Edge Conditioning Circuit 112 causing Power and Regeneration Switches (602, 604) to turn off, providing a protection circuit for both the AC Source 102 and the Load 130. A control signal is also sent to the Low Power Restart Circuit to restart and resynchronize the system 100. Otherwise, duty cycle control signals are continuously output to the Pulse Forming Circuit 108 by the High and Low Current Adjustment circuit 124.

When a low amount of current, relative to the Load, is sensed at the Current Feedback Circuit 122, a low current indication control signal is sent to the High and Low Current Adjustment Circuit 124, causing a Regeneration Period of the duty cycle to be increased and a Power Period of the duty cycle to be decreased. When a high amount of current, relative to the Load 130, is sensed at the Current Feedback Circuit 122, a high current indication control signal is sent to the High and Low Current Adjustment Circuit 124, causing the Regeneration Period of the duty cycle to be decreased and the Power Period of the duty cycle to be increased. These duty cycles then later control the opening and closing durations of the Power and Regeneration switches (602, 604), supplying current according to the demand of the Load 130. If the current sensed is high enough relative to the Load 130, the high current control signal will cause the Power Switch 602 to be closed, or on, 100% of the time, while the Regeneration Switch 604 remains open, or off. In this manner, the Pulse Forming Circuit 108 uses the current feedback signal to adjust the duty cycles of the output digital logic square wave pulse signal according to the demand of the Load 130.

The Pulse Forming Circuit 108 takes control signal input from the Steady State Synchronous Timing Circuit 106 and the High and Low Current Adjustment Circuit 124 to produce a chopped digital logic square wave pulse signal that is in sync with the AC Source 102, which automatically dynamically adjusts its pulse duration duty cycle according to the current feedback input determined by the demand of the Load 130, and sets the chopping frequency to a multiple of the AC Source 102 frequency.

The uninterrupted multiplied synchronized digital logic square wave pulse signal having a voltage level equal to the system logic voltage output from the Steady State Synchronous timing circuit 106 and the control signal output from the High and Low Current Adjustment Circuit 124 are input to the Pulse Forming Circuit 108. The Pulse Forming Circuit 108 takes the multiplied synchronized timing/clock reference signal and the current adjustment control information to determine the pulse width, or duty cycle (i.e on/off ratio of the square wave), outputting a chopped digital logic square wave pulse signal having anywhere from a 50% on/off ratio to a 100% on ratio. This duty cycle adjusts dynamically according to the amount of current being drawn by the Load 130, while remaining synchronized with the AC Source 102. In other words, the current sensing mechanism of the High and Low Current Adjustment Circuit 124 sends control signals comprising dynamic duty cycle information for pulse formation. If the Load 130 draws more current, the pulses are formed closer together. If the Load 130 draws less current, the pulses are formed farther apart. The square wave pulse duty cycles “open and close” in an accordion fashion as the current draw by the Load varies over time. The output signal of the Pulse Forming Circuit 108 is detailed in FIG. 11.

In one embodiment, the digital logic square wave pulse signal duty cycle can also be manually adjusted for an optimum setting for a particular non-varying Load such as a pump. For compressors or drill motors with varying Loads 130, the automatic control dynamically adjust for automatic optimum power savings. This AC synchronized duty cycle adjusted digital logic square wave pulse signal is input into the Startup Synchronization Circuit 110 along with the conjunctive control output signals of the Voltage Monitoring Circuit 104 and Low Power Restart Circuit 126.

The Startup Synchronization Circuit 110 is a timing delay circuit, which resynchronizes the synchronized clock reference signals during startup or after an interruption of the AC source 102. The Startup Synchronization Circuit 110 controls all of the logic for the Power and Regeneration Switches (602, 604) by using information from the current sensor and voltage monitor to determine instantaneous operational states for the Power and Regeneration Switches (602,604).

A Normal Start-up Sequence and operation comprises two consecutive timing delays. When the AC Source 102 supplies power to the system 100, a first predetermined charging delay holds the Power and Regeneration Switches (602,604) open, or off, until all of the circuits in the Simultaneously Switched Self Referenced AC Power Saving Regenerator system 100 are charged up to their operating voltages. Following completion of the first delay, a second operating delay holds the Power Switch 602 closed, or on, supplying full power to the Load 130. The duration of the second operating delay is determined by the turn on time of the individual Load 130. If, for example, the Load 130 is a large motor, up to 20 seconds or more could be required to spin up the motor to its full Revolutions Per Minute (RPM). After completion of the second operating delay and the Load 130 is running normally, digital logic square wave pulses generated by the Pulse Forming Circuit 108 are used to control the operation of the Power and Regeneration Switches (602,604).

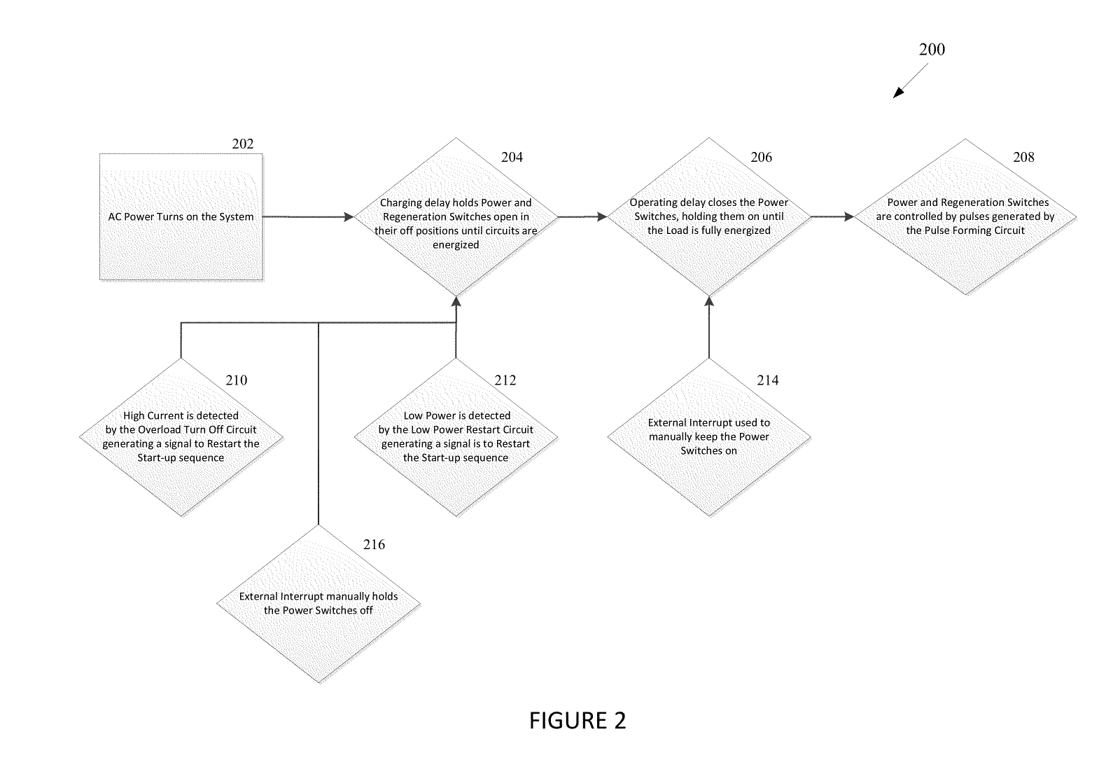

AC source interrupts, resets, and restarts are instances that interrupt normal operation of the system 100. In the case of AC Source 102 (or input power) discontinuity the Low Power Restart Circuit 126 issues a restart sequence control signal to the Startup Synchronization Circuit 110. In the case of a current overdraw by the Load 130 or intentional reset, the Over Load Turn Off Circuit 128 issues a restart control signal to the Low Power Restart Circuit 126 and an Edge Conditioning Circuit 112, causing the Power and Regeneration Switches (602,604) to turn off while a normal start-up sequence is performed. In various embodiments, the same startup synchronization mechanism is triggered by a temperature sensor integral the Load 130, or any other Load functions desirable to be monitored by the application. Digital logic square wave pulse signal output from the Startup Synchronization Circuit 110 is applied to the Edge Conditioning Circuit 112 for further logic processing. Operation of the Startup Synchronization Circuit 110 is further detailed in FIG. 2. The output signal of the Startup Synchronization Circuit 11 is detailed in FIG. 12.

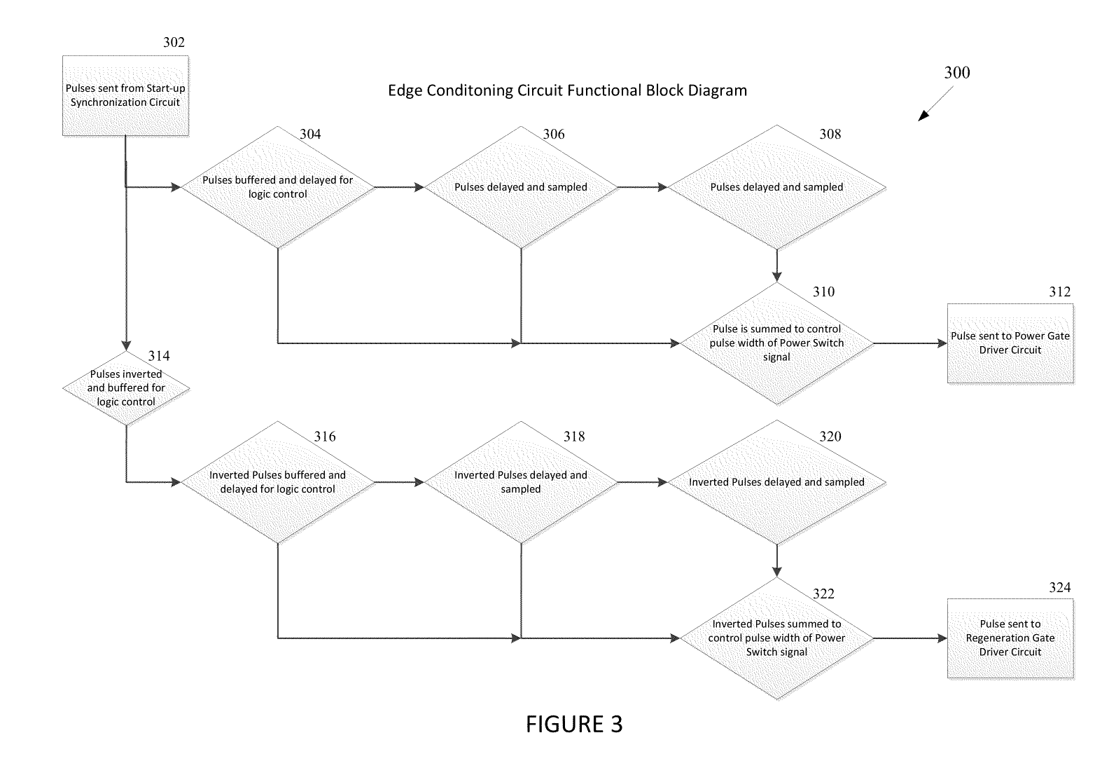

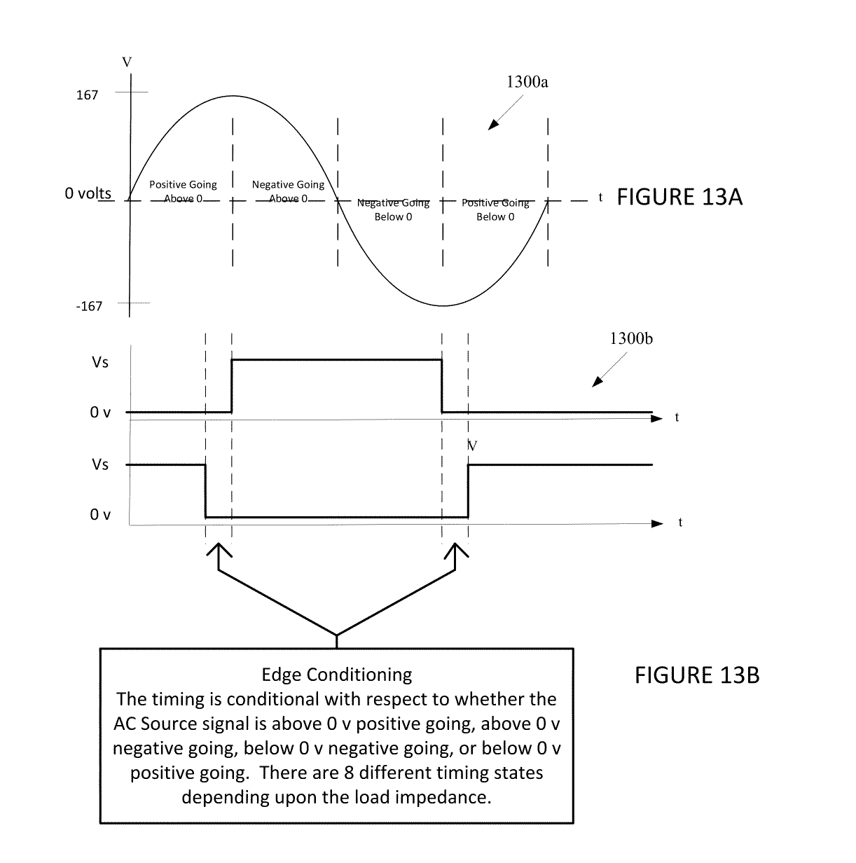

The Edge Conditioning Circuit 112 is comprised of logic gates for controlling the related timing, delay timing, rise times, and fall times of synchronized digital logic square wave output pulses simultaneously applied to a Power Gate Driver Circuit 114 and a Regeneration Gate Driver Circuit 118. The Power and Regeneration Switches (602,604) must behave differently as the voltage of the AC input signal varies over time because the reaction time of the Power and Regeneration Switches (602,604) is different at each instantaneous point in the slope of the AC Source 102 input power signal, creating four different operational states for the Power and Regeneration Switches (602,604) depending on an instantaneous slope and voltage value. Therefore, it necessary to pre-adjust the edges of signals applied to the Power Gate Driver Circuit 114 and the Regeneration Gate Driver Circuit 118 in order to ensure that the Power and Regeneration Switches (602,604) can never both be closed, or on, at the same time. This novel feature prevents shorting out of the AC Source 102 and damage to the Load 130 incurred by all previous traditional attempts to implement voltage regulating power saving devices. Operation of the Edge Conditioning Circuit 112 is further detailed in FIG. 3. The four different operational states for the Power and Regeneration Switches (602,604), which depend on the instantaneous slope and voltage values are detailed in FIG. 13A. Conditional timing output by the Edge Conditioning Circuit 112 is illustrated in FIG. 13B.

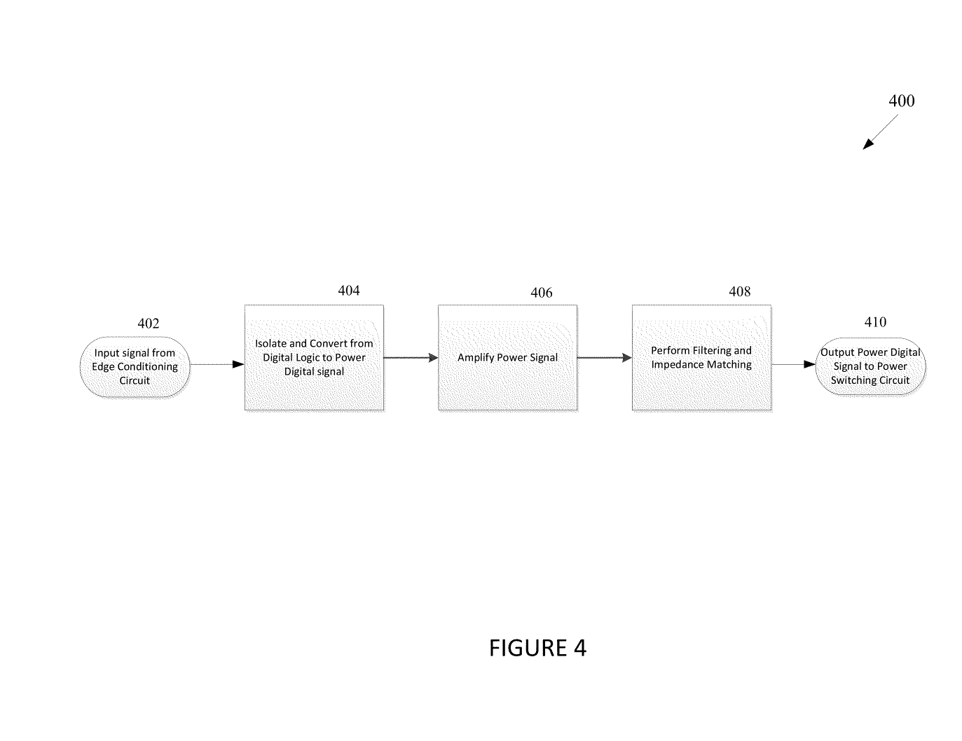

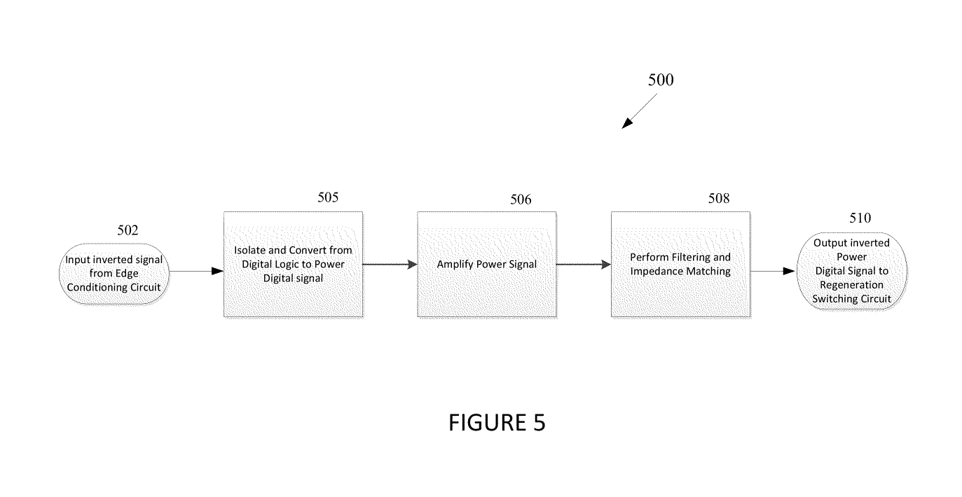

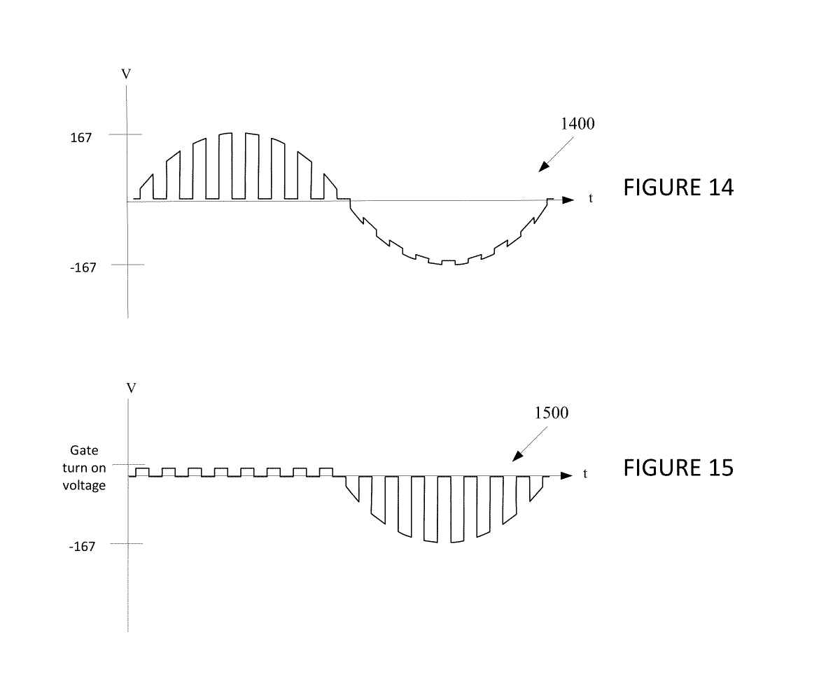

A Power Gate Driver Circuit 114 and a Regeneration Gate Driver Circuit 118 simultaneously receive an AC Source 102 input pre-synchronized edge conditioned current adjusted digital logic square wave pulse signal from the Edge Conditioning Circuit 112. Both of these circuits function is to isolate the Edge Conditioning Circuit 112 from the high power Power Switching 116 and Regeneration Switching 120 Circuits. Specially designed Power Gate Driver and Regeneration Gate Driver circuits (114, 118) convert the digital logic square wave pulse signal from a common digital logic square wave pulse waveform signal referenced to ground to the same signal referenced to the AC Source 102. After re-referencing the signal to the AC Source 102, the Power Gate Driver 114 and Regeneration Gate Driver 118 circuits function to properly amplify and gate the signal to the Power Switching Circuit 116 and Regeneration Switching Circuit 120. The Power Gate Driver 114 and Regeneration Gate Driver 118 circuits are designed to withstand high voltage spikes on the AC Source 102 power signal during switching by the Power Switching Circuit 116 and Regeneration Switching Circuit 120 as well as any strong current fluctuations. Operation of the Power Gate Driver Circuit 114 is further detailed in FIG. 4. Operation of the Power Gate Driver Circuit 118 is further detailed in FIG. 5. The output signal of the Power Gate Driver Circuit 114 is detailed in FIG. 14. The output signal of the Regeneration Gate Driver Circuit 118 is detailed in FIG. 15.

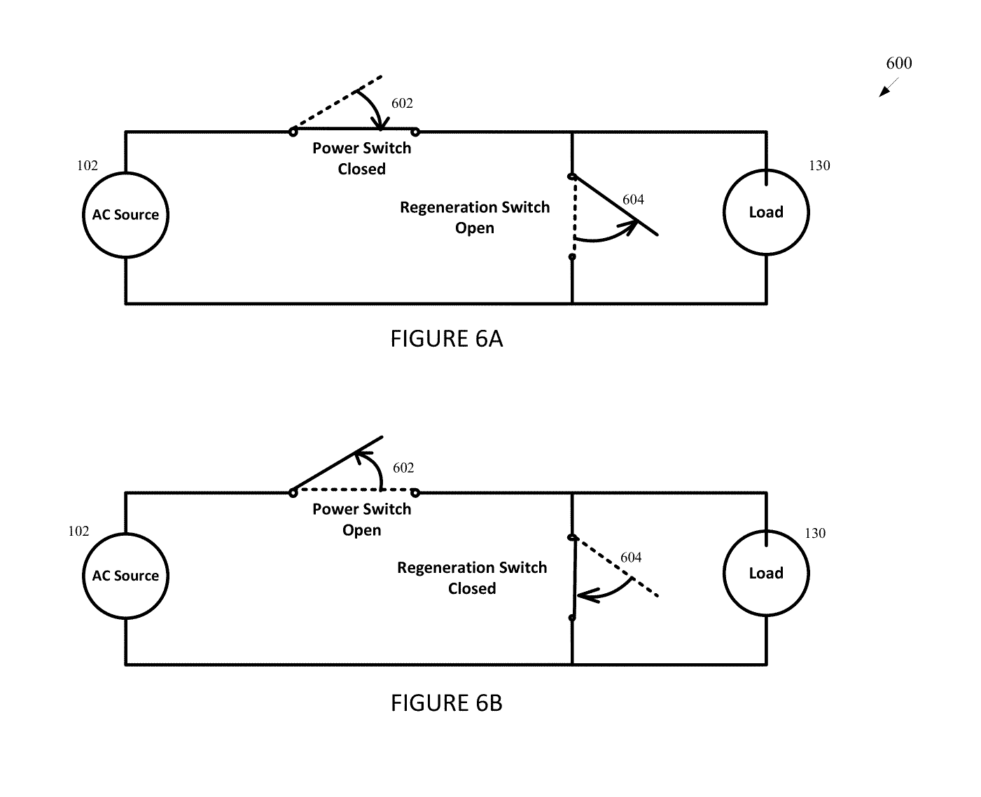

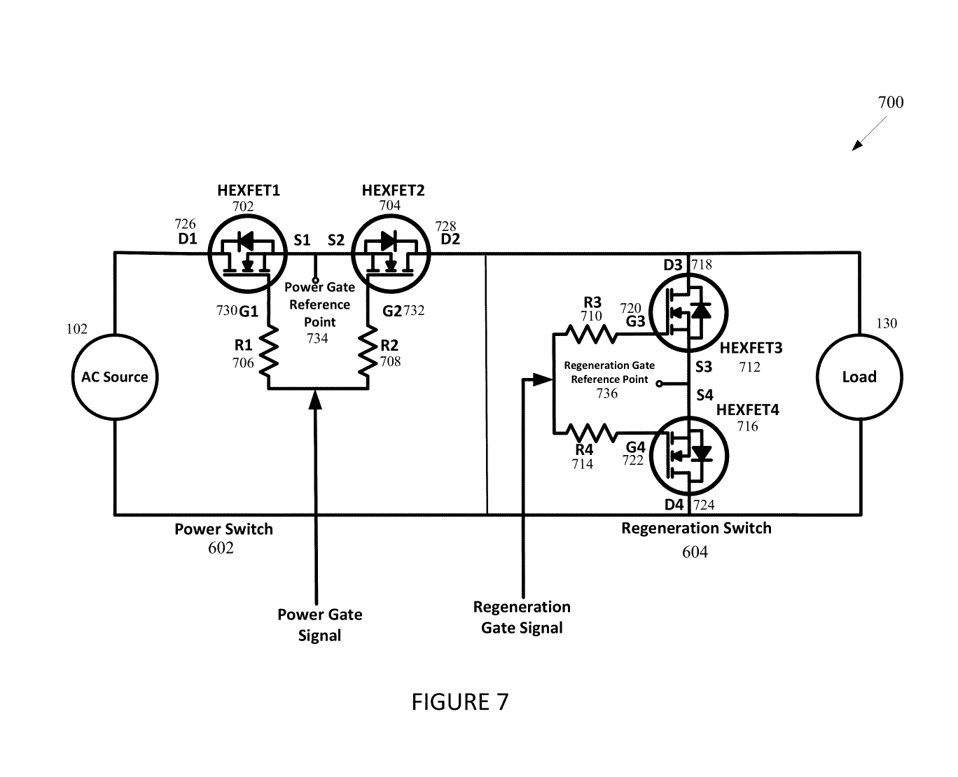

The Power Switching Circuit 116 and the Regeneration Switching Circuit 120 are simultaneously controlled by the signal input from the Power Gate Driver Circuit 116 and the Regeneration Gate Driver Circuit, respectively. In various embodiments, the Power Switching Circuit 114 and Regeneration Switching Circuit 118 comprise insulated-gate bipolar transistor (IGBTs), Hexfets, Mosfets, or BJTs with reverse gate diodes used as switches for AC source 102 power signals. Resistors are used at their gates to protect back current or voltage spikes from affecting connected drivers, buffers, or paired components. The operation of the Power Switching Circuit 116 and Regeneration Switching Circuit 120 is further detailed in FIG. 6A, FIG. 6B and FIG. 7.

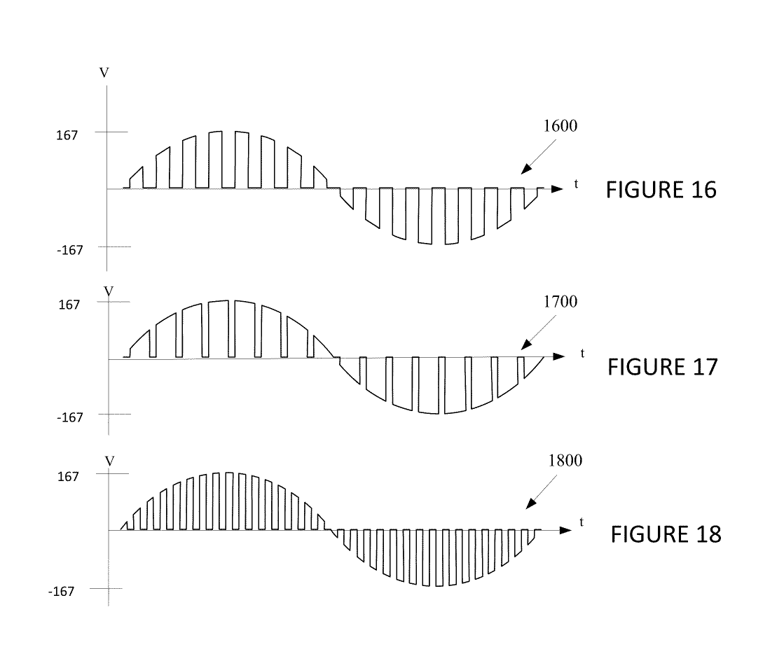

The Power Switching Circuit 116 and Regeneration Switching Circuit 120 are configured in series with the Load 130. Both outputs are connected directly to the Load 130. However, a series configuration is always maintained because due to the synchronization, edge conditioning, and gate driving previously applied to the digital logic square wave pulse signal, one and only one switching circuit can instantaneously supply the Load 130. The Load 130 may comprise any reactive device such as an inductor, capacitor, electric motor, incandescent light, transformer, or any other electric device that has a reactive response. The output signals of the Power Switching Circuit 116 and the Regeneration Switching Circuit 120 are detailed in FIGS. 16-18.

FIG. 2 is an exemplary flow diagram 200 detailing the operation of the Startup Synchronization Circuit 110 of a Synchronized Self-Referenced High Voltage Alternating Current Power Saving Regenerator Switch System 100. The Startup Synchronization Circuit 110 operates to cause two consecutive timing delays in the system 100 digital logic square wave pulse signal chain, first to allow all of the system circuits to energize, and then to allow the Load 130 to spin up, or fully energize, before synchronized power switching by the Power Switching and Regeneration Switching (116,120) Circuits begins.

Operation begins in step 202 when AC Power is applied to turn on the system 100. Control flow proceeds to step 204 where a first charging delay holds both the Power and Regeneration Switches (602,604) open (i.e. in their off positions) until all the system 100 circuits are fully energized. When the Power and Regeneration Switches (602,604) are open, no power is applied to the Load 130. Only the logic components of the various control circuits are powered. The charging delay times out after a predetermined length of time, which is sufficient for all the components of the individual embodiment to become energized and operational. When the charging delay completes, control flow proceeds to step 206.

The charging delay may be interrupted, causing the time out period to start over again. Interruptions may occur if the High and Low Current Adjustment Circuit 124 detects a current overdraw in step 210, causing the Over Load Turn Off Circuit 128 to generate a control signal to the Start-up Synchronization Circuit 110 to restart the system 100. Interruptions in the charging delay may also occur if the Low Power Restart Circuit 126 detects low power 212, causing the Low Power Restart Circuit 126 to generate a control signal to the Start-up Synchronization Circuit 110 to restart the system 100. Some embodiments may provide a “dead man switch”, or external interrupt 216, for manually holding the Power and Regeneration Switches (602,604) open, i.e off. Any interrupt of the charging delay restarts the charging delay timeout period. When a charging delay timeout period completes without any further interrupts, control flow proceeds to step 206.

In step 206, a second operating delay closes the Power Switch 602, holding it closed (i.e. on) while the Regeneration Switch 604 remains open (i.e. off), until the Load 130 is fully energized and allowed to spin up to its maximum RPMs. Again, some embodiments may provide a “dead man switch”, or external interrupt 214, for manually holding the Power and Regeneration Switches (602,604) open, (i.e off), as determined by the application. The operating delay times out after a length of time determined by the individual Load 130, which is sufficient for the Load 130 to operate at its maximum capacity. When the operating delay completes, control flow proceeds to step 208 where the Power and Regeneration Switches (602,604) are controlled by synchronized digital logic square wave pulses generated by the Pulse Forming Circuit 108 and conditioned by the Edge Conditioning Circuit 112.

FIG. 3 is an exemplary flow diagram illustrating digital logic square wave pulse signal edge conditioning 300 of a Synchronized Self-Referenced High Voltage Alternating Current Power Saving Regenerator Switch system 100. Edge conditioning provides timing delays and adjusts all rise and fall times of digital logic square wave pulse signals output to the Power Gate Driver 114 and Regeneration Gate Driver 118 Circuits, which cause the Power Switching 116 and Regeneration Switching 120 Circuits to operate in either a Power Mode or a Regeneration Mode detailed in FIGS. 6A and 6B. The timing delays and edge conditioning prevent the Power Switch 602 and Regeneration Switch 604 from being turned on (i.e. closed) at the same time, which protects the Load 130 and the system 100 from shorting and current overdraw. The system 100 operates in Power Mode when the Regeneration Switch 604 is off (i.e. open) and the Power Switch 602 is on (i.e closed). The system 100 operates in Regeneration Mode when the Power Switch 602 is off (i.e. open) and the Regeneration Switch 604 is on (i.e closed). The duty cycle of the edge conditioned digital logic square wave pules output by the Edge Conditioning Circuit 112 determine the length of time the Power Switch 602 remains open and the Regeneration Switch 604 remained closed or vice versa. This duty cycle is determined by the current draw of the Load 130.

The Edge Conditioning Circuit 112 buffers and delays the AC Source 102 synchronized input signal for logic control. First, the signal is buffered and sampled as required by individual Power and Regeneration Switches (602,604). The critical adjustments made by the Edge Conditioning Circuit 112 compensate for timing delays in the Power Gate Driver 114 and Regeneration Gate Driver 118 Circuits as well as the Power and Regeneration Switches (602,604) themselves. After the input digital logic square wave pulse signal is buffered and delayed a first time, it is buffered, delayed and sampled again before being applied to a summer and comparator circuit, which determine the length of the various digital logic square wave pulse signal timing delays. The output of the Edge Conditioning Circuit 112 is simultaneously input to the Power Gate Driver Circuit 114 detailed in FIG. 4, while an inverted output digital logic square wave pulse signal is supplied to the Regeneration Gate Driver Circuit 118 detailed in FIG. 5.

In this manner, the digital logic square wave pulse signal is adjusted for the Power Gate Driver 114 and Regeneration Gate Driver 118 Circuits so that both the Power Switch 602 and the Regeneration Switch 604 can never turn on (i.e. close) at the same time because there is always a critically calculated delay between them. Various embodiments and circuits may require digital logic square wave pulse signal timing advancements or delays. One skilled in the art would recognize that any timing requirements depend on the gate components selected for each individual embodiment. Critically calculated timing adjustments vary depending on whether the AC source 102 signal is positive going or negative going and whether its instantaneous voltage is above or below zero volts. Therefore, there are a total of 4 different critical timing calculations, two for each switch (602,604). For example when there is a positive going signal above zero, there may be a microsecond required delay between the Power Switch 602 and the Regeneration Switch 604 until the digital logic square wave pulse signal becomes negative going and the required delay becomes 500 nanoseconds. When the digital logic square wave pulse signal is below zero volts and still negative going, a 1.5 microsecond delay may be required, and as the digital logic square wave pulse signal rises again, there may be no required delay. Each critical delay is calculated by summing and comparing the various original and delayed digital logic square wave pulse signals. The duty cycle of the digital square wave pulses continues to be controlled by the current demand of the Load 130, and the digital logic square wave pulse signal remains in synchronization with the AC source 102.

In step 302, a digital logic square wave pulse signal is input from the Startup Synchronization Circuit 110. The digital logic square wave pulse signal input is also simultaneously inverted and buffered in step 314. Control flow then proceeds to Steps 304 and 316.

In step 304, the square wave pulses are buffered and delayed for logic control as described above. This buffered signal is provided to summer/comparator step 310. Control flow proceeds to step 306 where the buffered pulses are delayed and sampled a first time. This first delayed and sampled signal is also provided to the summer/comparator step 310. Control flow proceeds to step 308 where the square wave signal is delayed and sampled a second time. This twice delayed signal is also input to summer/comparator step 310. Control flow proceeds to step 310 where the summer/comparator calculates critical timing calculations to determine the pulse width of the square wave pulses, which later controls the operation of the Power Switch 602. The pulses are then input to the Power Gate Driver Circuit 114 in step 312.

In step 316, the inverted digital logic square wave pulses are buffered and delayed for logic control as described above. This buffered inverted digital logic square wave pulse signal is provided to summer/comparator step 322. Control flow proceeds to step 318 where the buffered inverted digital logic square wave pulses are delayed and sampled a first time. This first delayed and sampled inverted digital logic square wave pulse signal is also provided to the summer/comparator step 322. Control flow proceeds to step 320 where the inverted digital logic square wave pulse signal is delayed and sampled a second time. This twice delayed digital logic square wave pulse signal is also input to summer/comparator step 322. Control flow proceeds to step 322 where the summer/comparator calculates critical timing calculations to control the pulse width for the Regeneration Switch 604. The inverted digital logic square wave pulses are then input to the Regeneration Gate Driver Circuit 118 in step 324.

FIG. 4 is an exemplary flow diagram illustrating power gate driving 400 of a Synchronized Self-Referenced High Voltage Alternating Current Power Saving Regenerator Switch System 100. The Power Gate Driver Circuit 114 isolates and converts the digital logic square wave pulse signal referenced to the system switching logic voltage input from the Edge Conditioning Circuit 112 to a power digital square wave pulse signal referenced to the AC source for output to the Power Switching Circuit 116. Note that delays and reaction times in the Power Gate Driver Circuit 114 have previously been determined and accounted for by the Edge Conditioning Circuit 112. The converted power digital square wave pulse signal, now referenced to the AC source 102, is amplified to provide adequate power to drive the high voltage Power Switch 602. In one embodiment, impedance matching and filter circuits prevent fly back current from propagating through the system 100. The impedance matching circuit compensates for possible voltage spikes at the Power Switch 602. The filter network provides buffering and filtering to ensure that spikes do not return to the amplifier and impair the conversion from a digital logic square wave pulse signal to a power digital square wave pulse signal referenced to the AC source 102. The power digital square wave pulse signal output by the Power Gate Driver Circuit to the Power Switching Circuit 116 is detailed in FIG. 14.

In step 402, a digital logic square wave pulse signal referenced to the system 100 digital logic voltage is input from the Edge Conditioning Circuit 112. Control flow proceeds to step 404 where the digital logic square wave pulse signal is isolated from ground and converted to a power digital square wave pulse signal referenced to the AC Source 102 signal. The power digital square wave pulse signal is amplified to provide adequate power to drive the Power Switching Circuit 116 in step 406 Impedance matching and filtering of the power digital square wave pulse signal may be performed in step 408 before the amplified power digital square wave pulse signal is output to the Power Switching Circuit 116 in step 410.

FIG. 5 is an exemplary flow diagram illustrating regeneration gate driving 500 of a Synchronized Self-Referenced High Voltage Alternating Current Power Saving Regenerator Switch System 100. The Regeneration Gate Driver Circuit 118 isolates and converts the inverted digital logic square wave pulse signal referenced to the system switching logic voltage input from the Edge Conditioning Circuit 112 to an inverted power digital square wave pulse signal referenced to the AC source for output to the Regeneration Switching Circuit 120. Note that delays and reaction times in the Regeneration Gate Driver Circuit 118 have previously been determined and accounted for by the Edge Conditioning Circuit 112. The converted inverted power digital square wave pulse signal, now referenced to the AC source 102, is amplified to provide adequate power to drive the high voltage Regeneration Switch 604. In one embodiment, impedance matching and filter circuits prevent fly back current from propagating through the system 100. The impedance matching circuit compensates for possible voltage spikes at the Regeneration Switch 604. The filter network provides buffering and filtering to ensure that spikes do not return to the amplifier and impair the conversion from an inverted digital logic square wave pulse signal to an inverted power digital square wave pulse signal referenced to the AC source 102. Signal output by the Regeneration Gate Driver Circuit 118 to the Regeneration Switching Circuit 120 is detailed in FIG. 15.

In step 502, an inverted digital logic square wave pulse signal referenced to the system 100 digital logic voltage is input from the Edge Conditioning Circuit 112. Control flow proceeds to step 504 where the inverted digital logic square wave pulse signal is isolated from logic ground and converted to an inverted power digital square wave pulse signal referenced to the AC Source 102 signal. The inverted power digital square wave pulse signal is amplified to provide adequate power to drive the Regeneration Switching Circuit 120 in step 506 Impedance matching and filtering of the inverted power digital square wave pulse signal may be performed in step 508 before the amplified inverted power digital square wave pulse signal is output to the Regeneration Switching Circuit 120 in step 510.

FIG. 6 is an exemplary functional block diagram illustrating Power Mode and Regeneration Mode of a Synchronized Self-Referenced High Voltage Alternating Current Power Saving Regenerator Switch System 100. FIG. 6A illustrates Power Mode while FIG. 6B illustrates Regeneration Mode.

Diagrams 6A and 6B conceptually illustrate these two mutually exclusive critically timed modes of switching operation. This critically timed switching operation prevents both the Power Switch 602 and the Regeneration Switch 604 from closing at the same time in order to guarantee that the AC Source 102 will never be shorted. Simultaneous switching constraints are implemented to ensure that the Power Switch 602 and Regeneration Switch 604 work together such that they may never close at the same time. Properly synchronized simultaneous switching requires that all switching functions reference the AC Source, imposing the constraint that the switch timing reference of the Power Switch 602 and the Regeneration Switch 604 must be an exact multiple of the AC Source 102 frequency.

FIG. 6A illustrates Power Mode operation of the Power Switch 602 and the Regeneration Switch 604 showing the Power Switch 602 closing while the Regeneration Switch 604 opens. When the Power Switch 602 is closed, it supplies power to the Load 130, while the Regeneration Switch 604 remains open and does not pass a signal or affect the Load 130. In Power Mode, the AC Source 102 supplies power to the Load 130.

FIG. 6B illustrates Regeneration Mode operation of the Power Switch 602 and the Regeneration Switch 604 showing the Power Switch 602 opening while the Regeneration Switch 604 closes. When the Regeneration Switch 604 is closed, a circuit path is completed wherein reactive energy stored in the Load 130 is returned to the Load 130. Any reactive power stored in the Load 130 discharges through the Regeneration Switch 604, returning to the opposite side of the Load 130. The Power Switch 602 remains open and does not pass a signal or affect the Load 130. In Regeneration Mode, no power is being drawn from the AC Source 102, thus saving power.

FIG. 7 is a schematic diagram of an exemplary power gate and power regeneration gate circuit 700. The Power Switching 116 and Regeneration Switching 120 Circuits may be comprised of IGBT's, Hexfet's, Mosfet's, or BJT's with reverse gate diodes used as switches for switching AC Source 102 signals on and off according to a duty cycle previously determined by the current draw of the Load 130. Resistors R1-R4 (706,708,710, 714) at each gate protect the system 100 from back current or voltage spikes from affecting connected drivers, buffers, or paired components. Common to all of these devices, is that they are non-linear. Non-linear devices have different signal rise and fall times for off and on operation. The time required for a non-linear device to turn on is different than the time it takes to turn the device off. Therefore, controlling the gate timing of these non-linear devices is critical and must be performed precisely. Timing adjustments are made in the gate timing to balance the timing offsets of the rise and fall times of all non-linear devices by the Edge Conditioning Circuit 112.

Thus, eight switching modes or eight timing considerations involving the Hexfets, or other non-linear devices, where gate timing requires adequate consideration for the system to work properly are created by the four modes of the voltage signal and two switches. A first switching mode is defined when the AC Source 102 signal has a positive slope and a voltage value above zero. The rise time of the Power Switch 602 is simultaneously switched to match the fall time of the Regeneration Switch 604. A second switching mode is defined when the AC Source 102 signal has a positive slope and a voltage value above zero. The fall time of the Power Switch 602 is simultaneously switched to match the rise time of the Regeneration Switch 604. A third switching mode is defined when the AC Source 102 signal has a negative slope and a voltage value above zero. The rise time of the Power Switch 602 is simultaneously switched to match the fall time of the Regeneration Switch 604. A fourth switching mode is defined when the AC Source 102 signal has a negative slope and a voltage value above zero. The fall time of the Power Switch 602 is simultaneously switched to match the rise time of the Regeneration Switch 604. A fifth switching mode is defined when the AC Source 102 signal has a negative slope and a voltage value below zero. The rise time of the Power Switch 602 is simultaneously switched to match the fall time of the Regeneration Switch 604. A sixth switching mode is defined when the AC Source 102 signal has a negative slope and a voltage value below zero. The fall time of the Power Switch 602 is simultaneously switched to match the rise time of the Regeneration Switch 604. A seventh switching mode is defined when the AC Source 102 signal has a positive slope and a voltage value below zero. The rise time of the Power Switch 602 is simultaneously switched to match the fall time of the Regeneration Switch 604. An eighth switching mode is defined when the AC Source 102 signal has a positive slope and a voltage value below zero. The fall time of the Power Switch 602 is simultaneously switched to match the rise time of the Regeneration Switch 604. FIG. 13A details the AC Source 102 signal where the signal is separated into four sections with respect to zero volts as described in the 8 simultaneous switching modes disclosed above.

The Power Switching 116 and Regeneration Switching 120 circuits are novel differential circuits referenced only to themselves. These novel floating circuits are not Direct Current (DC) circuits and are never referenced to ground or any specific voltage. The instantaneous value of the AC Source 102 voltage is irrelevant because both power lines are open and the differential voltage is re-routed on to itself.

During startup, the Power Switch 602 and Regeneration Switch 604 are both open (i.e off) with no current flowing to the Load 130. Once all of the digital logic control circuits are fully energized and operational, the Power Switch 602 closes, turning on the Power Switching Circuit 116 and allowing current to flow from the AC Source 102 through the Power Switch 602 to the Load 130. The polarity of the voltage determines the direction of the current flow through the Power Switching 116 and Regeneration Switching 120 Circuits. This Power Switch 602 remains closed long enough for the Load 130 to be energized to its full capacity. For example, full power is applied to a motor until it has spun up to its full RPM. A current surge three to six times time the normal operational draw may be required to start up the motor. A pool pump regularly drawing 10 amps may draw 40-60 amps to spin up its motor. Therefore, the Power Switch 602 must remain closed so that full power remains applied to the Load during startup until normal operation commences.

During normal operation when AC Source 102 voltage input is positive, current reaches Hexfet1 702 of the Power Switch 602 and is blocked by its internal diode at drain D1 726. When gate G1 730 has a positive voltage signal and is switched on, current passes through Hexfet1 702 from drain D1 726 to source S1 734 and then continues to flow through Hexfet2's 704 internal diode to drain D2 728 to supply the Load 130. Current passes through the Load 130 and back to the AC Source 102. When the AC Source 102 voltage later becomes negative, current flows through the Load 130 in the opposite direction. Current flowing in this direction is blocked by internal diode in Hexfet2 704. When gate G2 732 has a positive voltage signal and is switched on, current flows through Hexfet2 704 from drain D2 728 to source S2 734 before passing through the internal diode of Hexfet1 702 to drain D1 726 and back to the AC Source 102.

During normal operation, when the Power Switch 602 is open (i.e. off), Hexfet1 702 and Hexfet2 704 are off. No current flows from the AC Source 102. Instead, the voltage and current being generated from the Load 130 are returned to the Load 130 through Hexfet3 712 and Hexfet4 716. Current regenerated by the Load 130 when the Load voltage is positive, reaches Hexfet3 712 of the Regeneration Switch 604 and is blocked by its internal diode. When gate G3 has positive voltage and is switched on, current passes through Hexfet3 712 from drain D3 718 to source S3 736 and then through Hexfet4's 716 internal diode to resupply the Load 130. When the Load 130 voltage later becomes negative, current flows from the Load 130 in the opposite direction. Current flowing in this direction is blocked by the internal diode of Hexfet4 716. When gate G4 has positive voltage and is switched on, the current flows through Hexfet4 from drain D4 724 to source S4 736 before passing through the internal diode of Hexfet3 712 and back to the Load 130. Power is saved during this Regeneration Mode.

A Power Gate Reference Point 734 and a Regeneration Gate Reference Point 736 are used by the Power Gate Driver Circuit 114 and Regeneration Gate Driver Circuit 118 respectively as a reference for the stabilizing the driver circuits by adjusting the voltage level of their signals. These reference points (734, 736) for the gate drivers float in accordance with the power digital square wave signal output.

Resistors at gates G1 730, G2 732, G3 720 and G4 722 protect the switching circuits from spikes internal to Hexfet1 702, Hexfet2 704, Hexfet3 712 and Hexfet4 716. These resistors isolate each gate from the other gates so that voltage spikes at one gate cannot cause oscillation at the other gates. Oscillation may cause uncontrolled switching resulting in shorting of the system 100.

FIG. 8 is an exemplary illustration of an original AC Source 102 power input signal 800 to a synchronized self-referenced high voltage alternating current power saving regenerator switch system 100. The original AC Source 102 power input signal 800 is referenced to itself. The voltage of the AC Source 102 power input signal 800 varies from a positive peak voltage value to a negative peak voltage value. In one embodiment, the positive and negative peak values of a 120V RMS AC Source signal are 167V and −167V respectively. One skilled in the art would recognize that alternative embodiments may comprise peak voltages of any value.

FIG. 9 is an exemplary illustration of a digital logic square wave output signal 900 of the Voltage Monitoring Circuit 104 where the AC Source 102 Frequency is converted to a square wave of the same frequency. This square wave having an AC Source frequency then becomes the clock timing reference signal for all of the digital logic components of a synchronized self-referenced high voltage alternating current power saving regenerator switch system 100. The digital logic square wave output signal 900 of the Voltage Monitoring Circuit 104 is referenced to ground. The voltage of the square wave output signal 900 of the Voltage Monitoring Circuit 104 switches between 0 Volts and the supply voltage (Vs) of the system's 100 digital logic components. In one embodiment, the square wave switches between 0V and 3.3V where the digital logic components comprise Transistor-Transistor Logic (TTL) integrated circuits. One skilled in the art would recognize that alternative embodiments may switch between any two voltage values.

FIG. 10 is an exemplary illustration of a digital logic square wave signal output signal 1000 of the Steady State Synchronous Timing Circuit 106. The Steady State Synchronous Timing Circuit 106 creates digital logic clock signals that are multiples of the AC Source 102 Frequency. FIG. 10 illustrates a digital logic clock signal that is 16 times the AC Source 102 frequency. The digital logic square wave signal output 1000 of the Steady State Synchronous Timing Circuit 106 is referenced to ground and has a 50% duty cycle. The voltage of the square wave output signal 1000 of the Steady State Synchronous Timing Circuit 106 switches between 0 Volts and the supply voltage (Vs) of the system's 100 digital logic components. In one embodiment, the square wave switches between 0V and 3.3V where the digital logic components comprise Transistor-Transistor Logic (TTL) integrated circuits. One skilled in the art would recognize that alternative embodiments may switch between any two voltage values.

FIG. 11 is an exemplary illustration of a digital logic square wave signal output signal 1100 of the Pulse Forming Circuit 108 where the output signal is 16 times the Source AC Frequency with a 25% Regeneration Period. The Current Feedback Circuit 122 and the High Low Current Adjust Circuit 124 determine the duty cycle of the output pulses. The digital logic square wave signal output signal 1100 of the Pulse Forming Circuit 108 is referenced to ground and has a duty cycle determined by the current draw on the Load 130. The voltage of the square wave output signal 1100 of the Pulse Forming Circuit 108 switches between 0 Volts and the supply voltage (Vs) of the system's 100 digital logic components. In one embodiment, the square wave switches between 0V and 3.3V where the digital logic components comprise Transistor-Transistor Logic (TTL) integrated circuits. One skilled in the art would recognize that alternative embodiments may switch between any two voltage values.

FIG. 12 is an exemplary illustration of a digital logic square wave output signal 1200 of the Startup Synchronization Circuit 110. During normal operation, the Startup Synchronization Circuit 110 operates as a pass through circuit such that its output signal is identical to the output signal of the Pulse Forming Circuit. The digital logic square wave output signal 1200 of the Startup Synchronization Circuit 110 is referenced to ground is referenced to ground and has a duty cycle determined by the current draw on the Load 130. The voltage of the square wave output signal 1200 of the Startup Synchronization Circuit 110 switches between 0 Volts and the supply voltage (Vs) of the system's 100 digital logic components. In one embodiment, the square wave switches between 0V and 3.3V where the digital logic components comprise Transistor-Transistor Logic (TTL) integrated circuits. One skilled in the art would recognize that alternative embodiments may switch between any two voltage values.

FIG. 13A illustrates four case variations over time of the AC input signal voltage, which create four different operational states for the Power and Regeneration Switches (602,604) depending on an instantaneous slope and voltage value of the AC input signal voltage. In case 1, the AC input signal comprises a positive voltage value and a positive slope. In case 2, the AC input signal comprises a positive voltage and negative slope. In case 3, the AC input signal comprises a negative voltage value and a negative slope. In case 4, the AC signal comprises a negative voltage value and a positive slope.

FIG. 13B is an exemplary illustration of a digital logic square wave output signal 1300 of the Edge Conditioning Circuit 112 showing conditional timing with respect to the four different operational states for the Power and Regeneration Switches (602,604), which depend on an instantaneous slope and voltage value of the AC input signal voltage detailed in FIG. 13A. These four operational states for each of the two switches create eight different timing states depending upon the Load 130 impedance. The digital logic square wave output signal 1300 of the Edge Conditioning Circuit 112 is referenced to ground. The voltage of the square wave output signal 1300 of the Edge Conditioning Circuit 112 switches between 0 Volts and the supply voltage (Vs) of the system's 100 digital logic components. In one embodiment, the square wave switches between 0V and 3.3V where the digital logic components comprise Transistor-Transistor Logic (TTL) integrated circuits. One skilled in the art would recognize that alternative embodiments may switch between any two voltage values.

FIG. 14 is an exemplary illustration of a power digital square wave pulse output signal 1400 of the Power Gate Driver Circuit 114 where the AC Source 102 Frequency is Chopped 16 times the source frequency with a 50% Regeneration Period. The digital logic square wave pulse output signal 1400 of the Power Gate Driver Circuit 114 is referenced to the AC Source 120 input signal and Power Gate Reference Point 734. The voltage of the Power Gate Driver Circuit 114 output signal varies from a positive peak voltage value to a negative peak voltage value. In one embodiment, the positive and negative peak values of a 120V RMS AC Source signal are 167V and −167V respectively. One skilled in the art would recognize that alternative embodiments may comprise peak voltages of any value.

FIG. 15 is an exemplary illustration of power digital square wave pulse output signal 1500 of the Regeneration Gate Driver Circuit 118 where the AC Source 102 Frequency is Chopped 16 times the source frequency with a 50% Regeneration Period. The digital logic square wave pulse output signal 1500 of the Regeneration Gate Driver Circuit 118 is referenced to the AC input signal and Regeneration Gate Reference Point 736. The voltage of the Regeneration Gate Driver Circuit 118 output signal varies from a gate turn on voltage value to a negative peak voltage value.

FIG. 16 is an exemplary illustration of a power digital square wave pulse output signal 1600 of the Power Switching Circuit 116 or the Regeneration Switching Circuit 120 where the AC Source 102 Frequency is chopped 16 times with a 50% duty cycle (or Regeneration Period). The Power Switching Circuit 116 and the Regeneration Switching Circuit 120 are differential circuits. The power digital square wave pulse output signal 1600 of the Power Switching Circuit 116 or the Regeneration Switching Circuit 120 are referenced to the AC input signal. The voltage of the Power Switching Circuit 116 or the Regeneration Switching Circuit 120 output signals vary from a positive peak voltage value to a negative peak voltage value. In one embodiment, the positive and negative peak values of a 120V RMS AC Source signal are 167V and −167V respectively. One skilled in the art would recognize that alternative embodiments may comprise peak voltages of any value.

FIG. 17 is another exemplary illustration of a power digital square wave pulse output signal 1700 of the Power Switching Circuit 116 or the Regeneration Switching Circuit 120 where the AC Source 102 Frequency is chopped 16 times with a 25% duty cycle (or Regeneration Period). The Power Switching Circuit 116 and the Regeneration Switching Circuit 120 are differential circuits. The power digital square wave pulse output signal 1700 of the Power Switching Circuit 116 or the Regeneration Switching Circuit 120 are referenced to the AC input signal. The voltage of the Power Switching Circuit 116 or the Regeneration Switching Circuit 120 output signals vary from a positive peak voltage value to a negative peak voltage value. In one embodiment, the positive and negative peak values of a 120V RMS AC Source signal are 167V and −167V respectively. One skilled in the art would recognize that alternative embodiments may comprise peak voltages of any value.

FIG. 18 is yet another exemplary illustration of a power digital square wave pulse output signal 1800 of the Power Switching Circuit 116 or the Regeneration Switching Circuit 120 where the AC Source 102 Frequency is chopped 32 times with a 50% Regeneration Period. The Power Switching Circuit 116 and the Regeneration Switching Circuit 120 are differential circuits. The power digital square wave pulse output signal 1800 of the Power Switching Circuit 116 or the Regeneration Switching Circuit 120 are referenced to the AC input signal. The voltage of the Power Switching Circuit 116 or the Regeneration Switching Circuit 120 output signals vary from a positive peak voltage value to a negative peak voltage value. In one embodiment, the positive and negative peak values of a 120V RMS AC Source signal are 167V and −167V respectively. One skilled in the art would recognize that alternative embodiments may comprise peak voltages of any value.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A switching system for saving Alternating Current power comprising:
an edge conditioning circuit for adjusting timing of a digital logic square wave pulse signal for input to gate driver circuits synchronized to an Alternating Current power source;
a power gate driver circuit for converting the timing adjusted digital logic square wave pulse signal to a power digital square wave pulse signal referenced to an Alternating Current power source for controlling a power switching circuit in a power mode;
a regeneration gate driver circuit for converting the timing adjusted digital logic square wave pulse signal to a power digital square wave pulse signal referenced to an Alternating Current power source for controlling a regeneration switching circuit in a regeneration mode;
a differential power switching circuit referenced to an Alternating Current power source configured in series with a reactive load for supplying power from the Alternating Current power source to the load in the power mode; and
a differential regeneration switching circuit referenced to an Alternating Current power source configured in series with the reactive load for saving power by reusing energy held by the load.

2. The switching system of claim 1 wherein the edge conditioning circuit prevents the system from operating in the power mode and regeneration mode at the same time.

3. The switching system of claim 1 wherein a pulse forming circuit adjusts the duty cycle of a digital logic square wave pulse signal according to a current demand of the load.

4. The switching system of claim 1 wherein the edge conditioning circuit adjusts for eight timing considerations created by four input power signal states applied to two non-linear switches.

5. The switching system of claim 1 wherein the edge conditioning edge circuit isolates the digital logic square wave pulse signal from logic ground.

6. The switching system of claim 1 wherein the power switching circuit is a differential floating circuit isolated from logic ground and referenced only to itself.

7. The switching system of claim 1 wherein the regeneration switching circuit is a differential floating circuit isolated from logic ground and referenced only to itself.

8. A method for saving power in Alternating Current devices comprising:
adjusting timing of a digital logic square wave pulse signal for input to gate driver circuits synchronized to an Alternating Current power source;
converting the timing adjusted digital logic square wave pulse signal to a power digital square wave pulse signal referenced to an Alternating Current power source for controlling a power switching circuit in a power mode;
converting the timing adjusted digital logic square wave pulse signal to a power digital square wave pulse signal referenced to an Alternating Current power source for controlling a regeneration switching circuit in a regeneration mode;
referencing a differential power switching circuit to an Alternating Current power source configured in series with a reactive load for supplying power from the Alternating Current power source to the load in the power mode; and
referencing a differential regeneration switching circuit to an Alternating Current power source configured in series with the reactive load for saving power by reusing energy held by the load.

9. The method of claim 8 wherein the edge conditioning circuit prevents the system from operating in the power mode and regeneration mode at the same time.

10. The method of claim 8 wherein a pulse forming circuit adjusts the duty cycle of a digital logic square wave pulse signal according to a current demand of the load.

11. The method of claim 8 wherein the edge conditioning circuit adjusts for eight timing considerations created by four input power signal states applied to two non-linear switches.

12. The method of claim 8 wherein the edge conditioning edge circuit isolates the digital logic square wave pulse signal from logic ground.

13. The method of claim 8 wherein the power switching circuit is a differential floating circuit isolated from logic ground and referenced only to itself.

14. The method of claim 8 wherein the regeneration switching circuit is a differential floating circuit isolated from logic ground and referenced only to itself.

15. A method for adjusting timing of a digital logic square wave pulse signal for input to a gate driver circuit synchronized to an Alternating Current power source comprising:
buffering, delaying and sampling signal pulses for logic control of high power switches;
summing and comparing the signal pulses to calculate critical timing adjustments;
adjusting timing of a digital logic square wave pulse signal according to the calculations.

16. The method of claim 15 wherein eight timing calculations are created for four input power signal states applied to two non-linear switches.

17. The method of claim 15 wherein the edge conditioning edge circuit isolates the digital logic square wave pulse signal from logic ground.

18. The method of claim 15 wherein an inverted signal is buffered, delayed and sampled.

19. The method of claim 15 wherein timing adjustments are calculated such that only one switch can apply power to a reactive load at any one time.

20. The method of claim 15 wherein the regeneration switching circuit is a differential floating circuit isolated from logic ground and referenced only to itself.
